(19) United States
(12) Patent Application Publication
(10) Pub. No.: US 2021/0192540 A1
(43) Pub. Date: Jun. 24, 2021

(54) COMPLIANCE AUDITING USING CLOUD BASED COMPUTER VISION

(71) Applicant: salesforce.com, inc., San Francisco, CA (US)

(72) Inventors: Mani Kandar Madduri, Hyderabad (IN); Nutana Sukumar Reddy MURAMREDDY, Hyderabad (IN); Piyush SINGH, Hyderabad (IN); Rajdeep Singh DUA, Hyderabad (IN); Mohan Krishna KUSUMA, Hyderabad (IN); Zineb LARAKI, San Francisco, CA (US); Ramkesh JHOORAWAT, Hyderabad (IN); Machiraju Pakasasana Rama RAO, Hyderabad (IN)

(73) Assignee: salesforce.com, inc., San Francisco, CA (US)

(21) Appl. No.: 17/098,766

(22) Filed: Nov. 16, 2020

(30) Foreign Application Priority Data
Nov. 16, 2019 (IN) 201941046743

(51) Int. Cl. G06Q 30/00; G06F 3/0484; G06K 9/62; G06Q 10/08; G06Q 30/06; G06K 7/14; G06N 20/00

(52) U.S. Cl. CPC G06Q 30/0185; G06F 3/04842; G06F 3/04845; G06K 9/6215; G06K 2007/10504; G06Q 30/0623; G06K 7/1447; G06N 20/00; G06Q 10/087

(57) ABSTRACT

Disclosed herein are system, method, and computer program product embodiments for compliance auditing using cloud based computer vision. In one aspect, a system is configured to visually present a set of compliance audits on a display of the mobile device. The system is also configured to receive a user selection to perform a computer vision assisted compliance audit and generate an audit image based at least on outputs received from an image acquisition component of the mobile device. The audit image is further transmitted to the mobile compliance backend system for computer vision assisted compliance auditing. The system then receives audit result information from the mobile compliance backend system, where the audit result information is visually presented on a display of the mobile device.

### CROSS REFERENCE TO RELATED APPLICATION

This application claims the benefit of priority to Indian Provisional Patent Application No. 201941046743 (Atty. Dkt. Nos. 3462.267IN00; IP51230/AY/rpra) filed on Nov. 16, 2019 in the Indian Patent Office, which is incorporated herein by reference in its entirety.

### BACKGROUND

Product manufacturers (e.g., consumer goods manufacturers, durable goods manufacturers, etc.) spend substantial efforts in visual merchandizing their products across various retailers. One method of visual merchandising is the use of planograms. Planograms typically consists of diagrams or models that define placements of one or more product or goods on a retailer's shelf. These planograms are often designed with the intent of maximizing sales. However, ensuring compliance, and thus, maximizing sales of products, takes substantial amount of effort and time. For example, this often requires a product manufacturer to send out compliance auditors to physically visit each retailer and visually inspect, using his or her best judgment, the compliance of a product manufacturer's planograms. With little time and substantial number of planograms to examine, compliance auditors are often pressed for time and may not be able exercise their best judgment. As such, a new, efficient, and consistent way of compliance auditing is needed.

### BRIEF DESCRIPTION OF THE DRAWINGS

The accompanying drawings are incorporated herein and form a part of the specification.

FIG. 1 illustrates an example embodiment of a mobile compliance auditing system using cloud based computer vision.

FIG. 2 illustrates an example embodiment of a mobile compliance application configured to perform compliance auditing using cloud based computer vision.

FIGS. 3A-3B illustrate example User Interface (UI) views of the mobile compliance application on a mobile device having a display device for initiating a compliance auditing using cloud based computer vision.

FIGS. 4A-4B illustrate example UI views of the mobile compliance application on a mobile device having a display device for viewing reference product information associated with an example compliance audit.

FIGS. 5A-5D illustrate example UI views of the mobile compliance application on a mobile device having a display device for performing an example compliance audit in the example retail store.

FIGS. 6A-6B illustrate example UI views of the mobile compliance application on a mobile device having a display device for filtering visually presented recognized product information associated with an example compliance audit.

FIGS. 7A-7B illustrate example UI views of the mobile compliance application on a mobile device having a display device for viewing at least a portion of reference product information and/or product performance indicator information associated with an example compliance audit.

FIGS. 8A-8F illustrate example UI views of the mobile compliance application on a mobile device having a display device for providing user feedback to the cloud based computer vision compliance system by adding or modifying a product tag for a product that was not recognized in an example compliance audit.

FIG. 9 illustrates an example UI view of the mobile compliance application on a mobile device having a display device after recognizing all products and/or adding product tags for all unrecognized products in an example compliance audit.

FIG. 10 illustrates an example UI view of the mobile compliance application on a mobile device having a display device after all example compliance audits have been completed.

FIG. 11 illustrates an example logic flow for performing an example compliance audit on a mobile device.

FIG. 12 illustrates an example logic flow for modifying product tags associated with a compliance audit on a mobile device.

FIG. 13 illustrates an example computer system useful for implementing various embodiments.

In the drawings, like reference numbers generally indicate identical or similar elements. Additionally, generally, the left-most digit(s) of a reference number identifies the drawing in which the reference number first appears. Furthermore, one or more designators to the right of a reference number such as, for example, “a” and “b” and “c” and other similar designators are intended to be variables representing any positive integer. Thus, for example, if an implementation sets a value for a=4, then a set of elements 104-a may include elements 114-1, 114-2, 114-3, and 114-4.

### DETAILED DESCRIPTION

Provided herein are system, apparatus, article of manufacture, method and/or computer program product embodiments, and/or combinations and sub-combinations thereof, for compliance auditing using cloud based computer vision services.

Moreover, to provide a new, efficient, and consistent way of compliance auditing, disclosed herein are various embodiments that leverage cloud based object detection or recognition capabilities to enable one or more users (e.g., compliance auditors, sales representatives, merchandisers, etc.) to take pictures of products on a store shelf and recognize products to ensure their compliance with a product manufacturer's marketing campaign (e.g., one or more planograms). Moreover, the cloud based object recognition relies on one or more trained object recognition models for helping users efficiently and consistently recognize products and assess various performance indicators. The various embodiments also provide capabilities in a mobile compliance application that enable a user to train one or more object recognition models visually in a physical store by identifying regions of an audit image that correspond to a particular existing or even new product. This training via a mobile compliance application allows one or more users to continuously improve the object recognition capabilities of one or more object recognition models through one or more compliance audits. Further features and advantages, as well as the structure and operation of various embodiments, are described in detail below with reference to the accompanying drawings.

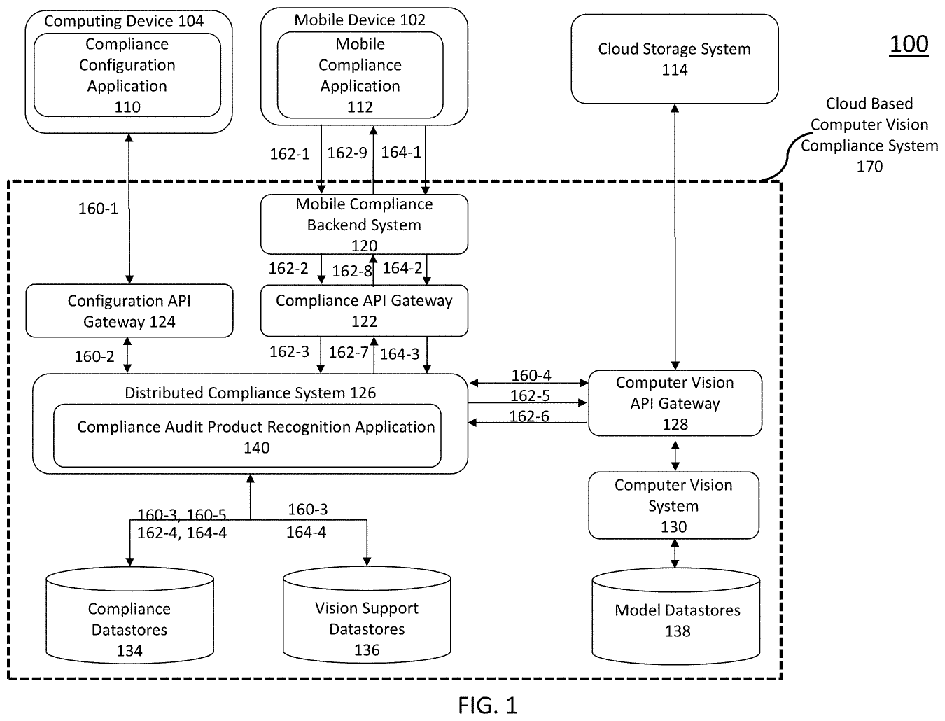

FIG. 1 illustrates an example block diagram according to an example embodiment of a mobile compliance auditing system 100 using one or more computer vision services. In one embodiment, the one or more computer vision services may also be configured to efficiently select a minimum set of object recognition models for use in object recognition. In one embodiment, the mobile compliance auditing system 100 may include, without limitation, computing device 104, mobile device 102, and cloud storage system 114. Although not explicitly illustrated, it is to be appreciated that these devices and system may be operatively coupled via the Internet and/or one or more intranets. Additionally, the computing device 104, the mobile device 102, and the cloud storage system 114, may also be operatively coupled to the cloud based computer vision compliance system 170 via the Internet and/or one or more intranets to facilitate the training, testing, validation, and experimentation of the computer vision system 130 and mobile compliance auditing.

In one embodiment, the cloud based computer vision system 170 may include configuration application program interface (API) gateway 124, which may be further operatively coupled to the distributed compliance system 126. In one embodiment, the distributed compliance system 126 may be operatively coupled to the compliance datastores 134 (e.g., persistent compliance datastores) and vision datastores 136. Additionally, the cloud based computer vision system 170 include a mobile compliance backend system 120, which may be operatively coupled to the compliance API gateway 122 and further operatively coupled to the distributed compliance system 126. The distributed compliance system 126 may be operatively coupled to the computer vision API gateway 128, which is operatively coupled to the computer vision system 130 and the cloud storage system 114. The computer vision system 130 may be further operatively coupled to the model datastores 138. It is to be appreciated that all the gateways, systems, and/or datastores within the cloud based computer vision system 170 may be operatively coupled via the Internet and/or one or more intranets to allow one or more users to perform compliance auditing using cloud based computer vision services.

In one embodiment, the computing device 104 may be representative of a product manufacturer's (e.g., consumer goods manufacturer, durable goods manufacturer, etc.) computing device 104 that is configured to execute a compliance configuration application 110. In one embodiment, the compliance configuration application 110 may be configured as a web based application or a native application executing on the computing device 104.

In one embodiment, the compliance configuration application 110 may be configured to allow a user associated with a product manufacturer to provide or otherwise generate experimentation, testing, training, and validation datasets that are used to train/retrain, test, and/or validate the computer vision system 130 via the computer vision API gateway 128. In one embodiment, the compliance configuration application 110 may also be configured to allow a user associated with a product manufacturer to provide compliance audit information which may include information relating to one or more visual marketing campaigns (e.g., one or more planograms) at one or more physical locations (e.g., stores).

In one embodiment, the configuration API gateway 124 may provide one or more APIs to allow one or more applications (e.g., the compliance configuration application 110, etc.) to communicate with the distributed compliance system 126. For example, the configuration API gateway 124 may be configured to manage any incoming requests and provide corresponding responses between the one or more applications and the distributed compliance system 126 in accordance with a specified communication protocol.

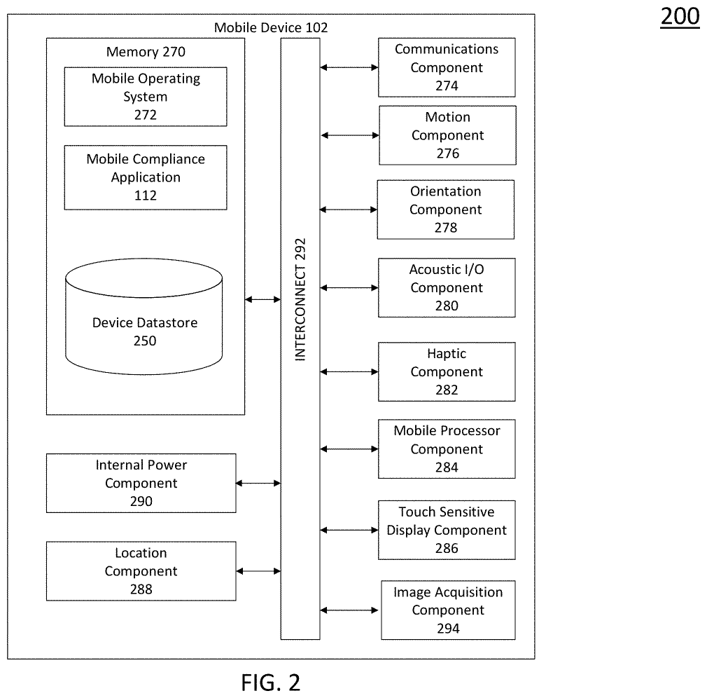

In one embodiment, the mobile device 102 further discussed with respect to FIG. 2 may be representative of a product manufacturer's (e.g., consumer goods manufacturer, durable goods manufacturer, etc.) mobile device (e.g., a mobile phone, tablet, laptop, etc.) that is configured to execute a mobile compliance application 112. In one embodiment, the mobile compliance application 112 may be configured as a web based application or a native application executing on the mobile device 102. While not illustrated, it is to be appreciated that the mobile device 102 may also be configured to execute the compliance configuration application 110 as a web based application or a native application.

In one embodiment, the mobile compliance backend system 120 may be configured to interface with the mobile compliance application 112 to provide appropriately formatted information to and from the mobile compliance application 112 and communicate with the compliance API gateway 122. The mobile compliance backend system 120 may be further configured to maintain state information associated with the mobile compliance application 112.

In one embodiment, the compliance API gateway 122 may be configured to allow the one or more systems (e.g., mobile compliance backend system 120, etc.) to communicate with the distributed compliance system 126. For example, the compliance API gateway 122 may be configured to manage any incoming requests and provide corresponding responses between the mobile compliance backend system 120 and the distributed compliance system 126 in accordance with a specified communication protocol.

In one embodiment, the distributed compliance system 126 may be configured to allow a user to create, store, and/or otherwise manage one or more experimentation, testing, training, and validation datasets that are used to train/retrain, test, and/or validate the computer vision system 130 via the computer vision API gateway 128. In one embodiment, the distributed compliance system 126 may also be configured to provide information stored in the compliance datastores 134 (e.g., compliance audit information, one or more object recognition model lists that may include one or more object recognition model identifiers and one or more recognized product names (or labels) corresponding to each object recognition model identifier, dataset identifiers, etc.) and vision support datastores 136 (e.g., experimentation, validation, training, and/or testing datasets, etc.) to the computer vision system 130, the compliance configuration application 110, and/or the mobile compliance application 112. Additionally, or alternatively, the distributed compliance system 126 may be configured to request the computer vision system 130 via the computer vision API gateway 128 to retrieve or store information (e.g., experimentation, validation, training, and/or testing datasets, etc.) in the cloud storage system 114 via a uniform resource locator (URL).

In one embodiment, the distributed compliance system 126 may include, without limitation, compliance audit product recognition application 140. In one embodiment, the compliance audit product recognition application 140 may be configured to select a minimum set of object recognition models for one or more audit images associated with one or more compliance audits. In one embodiment, the compliance audit product recognition application 140 may be further configured to request the computer vision system 130 to apply the minimum set of object recognition models to an audit image for a particular compliance audit.

In one embodiment, the distributed compliance system 126 may also be configured to generate audit result information based at least on the recognized product information for each recognized product (e.g., a recognized product in a planogram) received from the computer vision system 130. To generate the audit result information, the distributed compliance system 126 may be configured to at least filter and/or combine recognized product information for each recognized product received from the computer vision system 130 based at least on the probability of correct identification that identifies the probability that the object recognition model correctly identified the recognized object (e.g., correctly identified the recognized product). In one embodiment, the distributed compliance system 126 may be configured to request the computer vision system 130 to retrain one or more object recognition models on a periodic basis (e.g., daily, weekly, monthly basis, etc.) using one or more training datasets.

In one embodiment, the computer vision API gateway 128 may provide one or more APIs to allow one or more systems (e.g., distributed compliance system 126, etc.) to communicate with the computer vision system 130. For example, the computer vision API gateway 128 may be configured to manage any incoming requests and provide corresponding responses between the computer vision system 130 and distributed compliance system 126 in accordance with a specified communication protocol.

In one embodiment, the computer vision system 130 may be configured to generate one or more object recognition models based at least on one or more training and/or experimentation datasets. Each trained object recognition model may be identified by an object recognition model identifier that identifies a specific object recognition model. Each trained object recognition model may also be associated with one or more products having corresponding product names (or labels) that the trained object recognition model is capable of recognizing (e.g., detect, classify, locate, identify, etc.) within an audit image. Each trained object recognition model may be stored in the model datastore 138 operatively coupled to the computer vision system 130. Additionally, each trained object recognition model's object recognition model identifier and associated one or more product names (or labels) may be aggregated in one or more object recognition model lists. The one or more object recognition model lists may be stored in the model datastore 138, which is operatively coupled to the computer vision system 130, Additionally, the one or more object recognition model lists may also be stored in the compliance datastores 134, which is operatively coupled to the distributed compliance system 126.

In one embodiment, the computer vision system 130 may be configured to retrain one or more object recognition models identified by its corresponding object recognition model identifier using one or more datasets stored in the vision datastores 136 and/or in cloud storage system 114 based on a universal resource locator (URL).

In one embodiment, the computer vision system 130 may also be configured to apply one or more object recognition models identified by its corresponding object recognition model identifier to recognize one or more products within an audit image using one or more object recognition algorithms (e.g., Convolutional Neural Network (CNN), You Only Look Once (YOLO), etc.). In one embodiment, the computer vision system 130 may also be configured to provide at least a portion of recognized product information for each recognized product.

For example, the recognized product information may include, without limitation, one or more recognized product tags that identifies one or more rectangular regions of a recognized product within the audit image (e.g., recognized product tag UI element 520-1, etc.), a recognized product name identifying a name (or a label) of the recognized product within the audit image, a recognized product unique identifier that uniquely identifies the recognized product, and recognized product facing count that indicates a number of facings for a recognized product within the audit image. Additionally, and for each recognized product, the computer vision system 130 may also be configured to provide an object recognition model identifier that identifies an object recognition model that was applied and probability of correct identification that identifies the probability that the object recognition model correctly identified the recognized object.

In one embodiment, the vision support datastores 136 (e.g., Salesforce files, etc.) may be configured to store experimentation, testing, training, and/or validation datasets for training one or more object recognition models. Each dataset may correspond to a dataset identifier. Each dataset may include one or more product images, corresponding one or more product names, and corresponding one or more product tags that identify a region (e.g., a rectangular region) of where the product is within the one or more product images (e.g., csv file identifying pixel coordinates of the rectangular region). In one embodiment, the cloud storage system 114 (e.g., Dropbox, Google Drive, etc.) may be configured to store experimentation, testing, training, and/or validation datasets which may be identified by an associated URL.

In one embodiment, the compliance datastores 134 may be configured to manage metadata associated with the one or more experimentation, testing, training, and validation datasets and one or more object recognition models (e.g., one or more object recognition model lists that may include one or more object recognition model identifiers, one or more object or product names corresponding to each object recognition model identifier, dataset identifier corresponding to each dataset, etc.) generated by the computer vision system 130 and/or distributed compliance system 126.

Additionally, the compliance datastores 134 may also be configured to store at least a portion of the compliance audit information which may include information relating to one or more visual marketing campaigns (e.g., one or more planograms) at one or more physical locations (e.g., stores) for one or more product manufacturers. For example, the compliance audit information for a planogram may include a reference image that is compliant and includes of one or more reference products for sale as arranged at a physical location (e.g., a planogram in a store, etc.), the compliance audit information may further include a set of reference products included in the reference image, where each reference product is represented as reference product information. Additionally, the compliance audit information may also include an audit identifier that uniquely identifies a particular compliance audit using, for example, an alphanumeric identifier.

In one embodiment, the reference product information for each reference product may include a reference product image that represents a digital image of a physical product for sale within the reference image, a reference product name identifying a name (or label) of the reference product, a reference product placement description that identifies a placement location of the reference product and a number of facings at the placement location, a reference product facing count that indicates a number of facings for the reference product within the reference image, and a reference product share of shelf that identifies a percentage of the reference product facing count as compared to all available facings within the reference image.

In a first example operation as illustrated in FIG. 1, a user associated with a product manufacturer may at stage 160-1 provide training, testing, and/or validation datasets to the distributed compliance system 126 using the compliance configuration application 110. In response, at stage 160-2, the configuration API gateway 124 may provide the datasets to the distributed compliance system 126. At stage 160-3, the distributed compliance system 126 may be configured to store the datasets in vision support datastores 136 and assign associated dataset identifiers to each of the datasets. Additionally, the distributed compliance system 126 may also store the dataset identifiers in the compliance datastores 134.

Continuing with the above first example operation and at stage 160-4, the distributed compliance system 126 may request the computer vision API gateway 128 to generate one or more object recognition models based at least on: (1) one or more experimentation, testing, training, and/or validation datasets identified by their respective dataset identifiers and stored in the vision support datastores 136, and/or (2) one or more experimentation, testing, training, and/or validation datasets identified by their respective URLs (and/or dataset identifiers) and stored in the cloud computing system 114. Additionally or alternatively, the distributed compliance system 126 at stage 160-4 may transmit the one or more stored datasets and associated dataset identifiers to the computer vision system 130 via the computer vision API gateway 128 and request the computer vision API gateway 128 to generate one or more object recognition models based at least on one or more datasets transmitted to the computer vision system 130. In response, the computer vision system 130 may generate one or more object recognition models and associated object recognition model identifiers. At stage 160-5, the distributed compliance system 126 may be configured to store the associated object recognition model identifiers and corresponding recognized product names (or labels) in the compliance datastores 134 as one or more object recognition model lists.

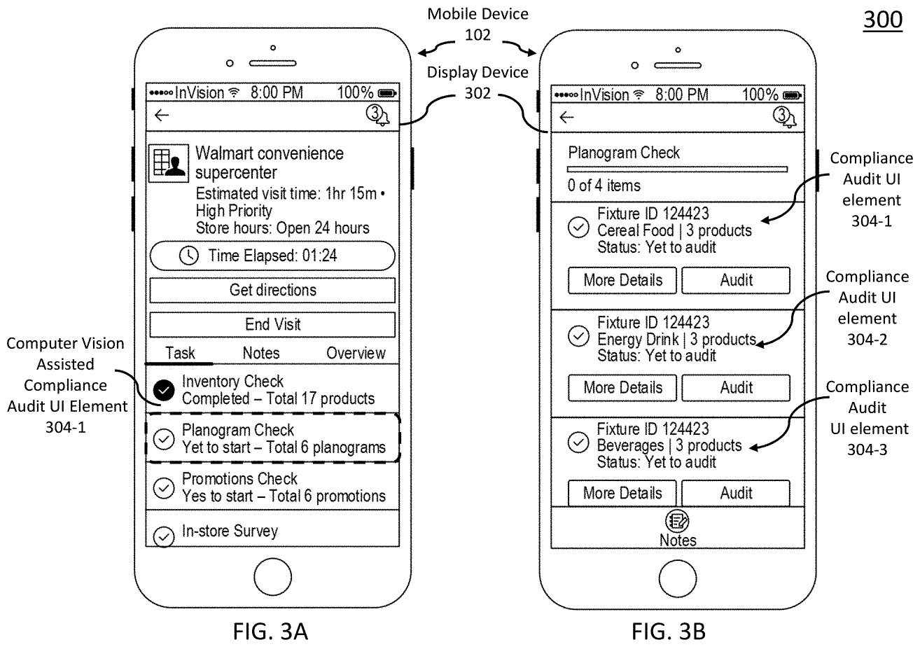

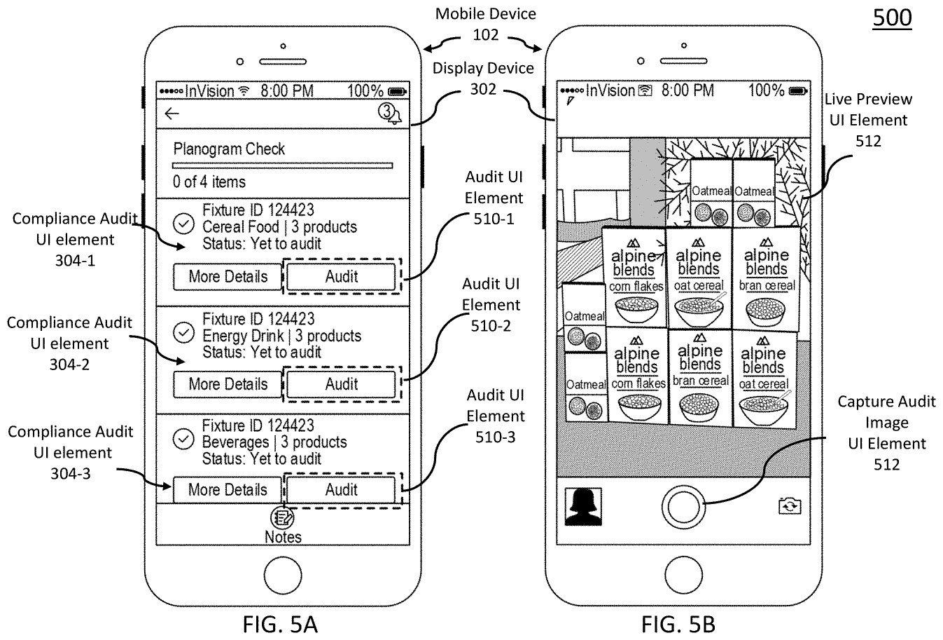

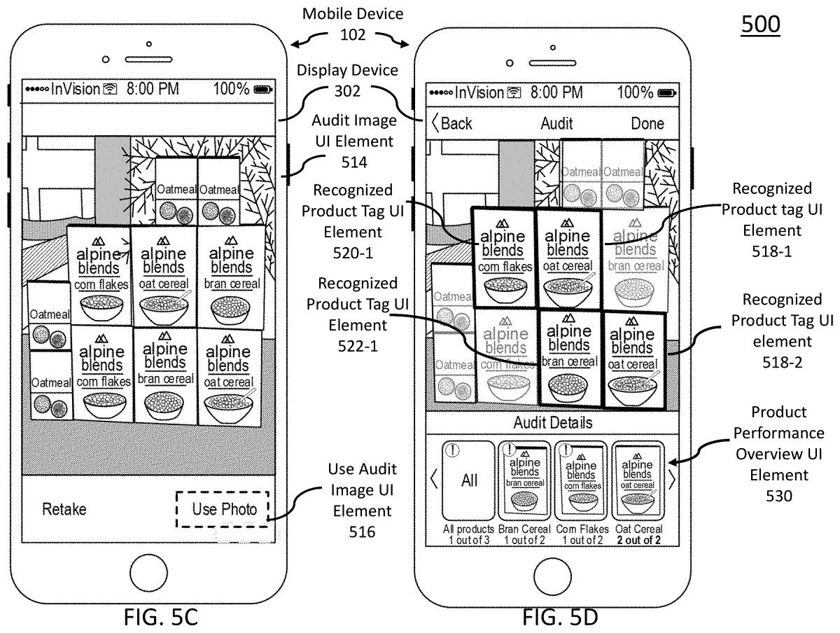

In a second example operation as illustrated in FIG. 1, a user (e.g., a compliance auditor) associated with a product manufacturer may at stage 162-1 request a compliance audit for a planogram at a particular store using the mobile compliance application 112, which is further discussed with respect to at least FIGS. 3A-3B and 5A-5D. Moreover, at stage 162-1, the mobile compliance application 112 may transmit a compliance audit request, which may include, without limitation, an audit image generated by the mobile compliance application 112. In response, at stage 162-2, the mobile compliance backend system 120 may provide the compliance audit request to the compliance API gateway 122. At stage 162-3, the compliance API gateway 122 may provide the compliance audit request to the distributed compliance system 126.

Continuing with the above second example operation and at stage 162-3, in response to the received compliance audit request, the compliance audit product recognition application 140 of the distributed compliance system 126 may determine: (1) a required product recognition list that identifies a list of product names that are to be recognized for a particular compliance audit; and (2) an object recognition model list that identifies a list of object recognition model identifiers and corresponding recognized product names for a particular product manufacturer and its marketing campaign.

To determine the required product recognition list and the object recognition model list, at stage 162-4, the compliance audit product recognition application 140 may use the audit identifier received in the compliance audit request to request a corresponding compliance audit information and an object recognition model list from the compliance datastores 134. In response, the compliance audit product recognition application 140 may receive the corresponding compliance audit information and object recognition model list from the compliance datastores 134. The compliance audit product recognition application 140 may then generate the required product recognition list by using the one or more reference product names from the received compliance audit information. The one or more product names may identify various products that are to be recognized by computer vision system 130 for the compliance audit request.

Continuing with the above second example operation and at stage 162-5 and based on the compliance audit request, the compliance audit product recognition application 140 may further request the computer vision API gateway 128 to apply a minimum set of object recognition models for a particular compliance audit to the audit image to recognize one or more products within the audit image.

In response at the stage 162-6, the computer vision system 130 may generate recognized product information for each recognized product in the audit image. Additionally, and for each recognized product, the computer vision system 130 may also be configured to provide an object recognition model identifier that identifies an object recognition model that was applied and a probability of correct identification that identifies the probability that the object recognition model correctly identified the recognized object.

Continuing with the above second example operation and at stage 162-7, the distributed compliance system 126 may be configured to generate audit result information based on the recognized product information for each recognized product received from the computer vision system 130. To generate the audit result information, the computer vision system 130 may be configured to filter and/or combine recognized product information for each recognized product received from the computer vision system 130 based at least on the probability of correct identification that identifies the probability that the object recognition model correctly identified the recognized object.

Furthermore, the audit result information may also include product performance indicator information. Moreover, the distributed compliance system 126 may be configured to determine the product performance indicator information based at least on a comparison between the compliance audit information and the audit result information for the compliance audit. In one embodiment, the product performance indicator information may include, without limitation, facing count comparison information for each reference product determined based at least on comparison between a recognized product facing count and a reference product facing count for each reference product. The product performance indicator information may then be visually presented to a user to indicate deficiencies in a compliance audit.

Additionally, the audit result information may also include out-of-compliance product information. Moreover, the distributed compliance system 126 may also be configured to determine out-of-compliance product information for each product that was not recognized in the audit image based at least on product performance indicator information and/or reference product information for each reference product in the compliance audit. In one embodiment, the out-of-compliance product information for each product that was not recognized may include, without limitation, an unrecognized product tag identifying a rectangular region where a specific product was expected to be within the audit image but was not recognized. The out-of-compliance product information may then be visually presented to a user to indicate any additional deficiencies in the compliance audit and how to correct such deficiencies in a particular compliance audit.

At stage 162-8, the distributed compliance system 126 may be configured to provide the audit result information to the compliance API gateway 122. In response at stage 162-7, the compliance API gateway 122 may provide the audit result information to the mobile compliance backend system 120. At stage 162-9, the mobile compliance backend system 120 may then provide the audit result information to the mobile compliance application 112, which is further discussed and illustrated in at least FIG. 5D.

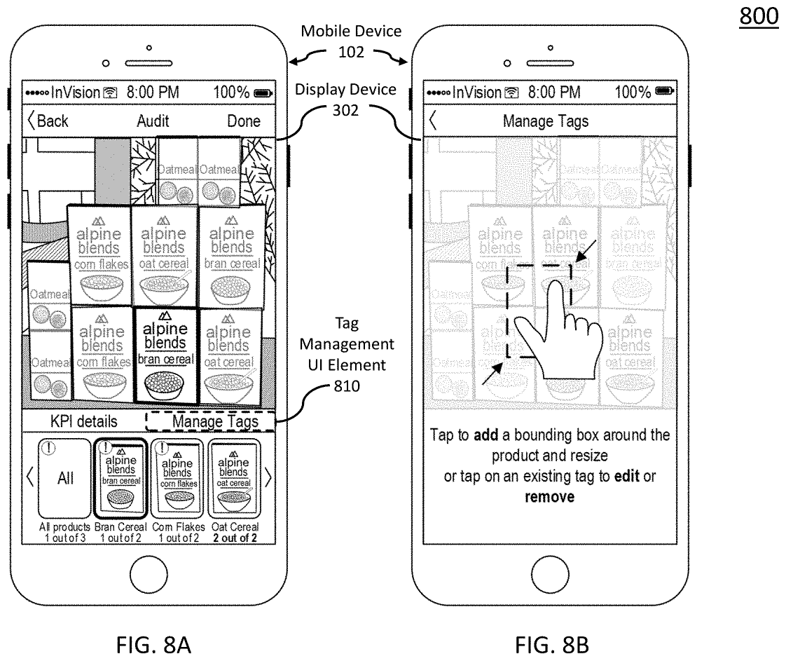

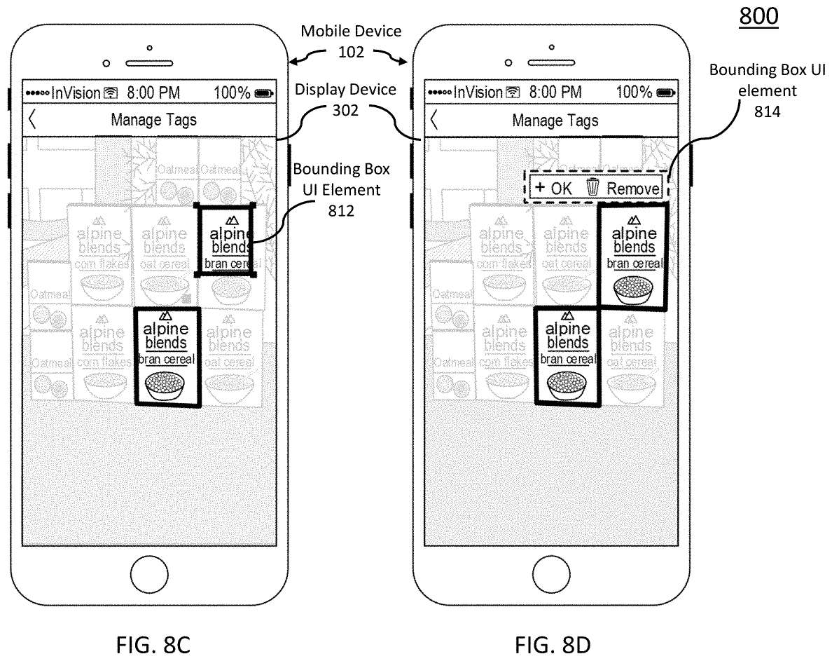

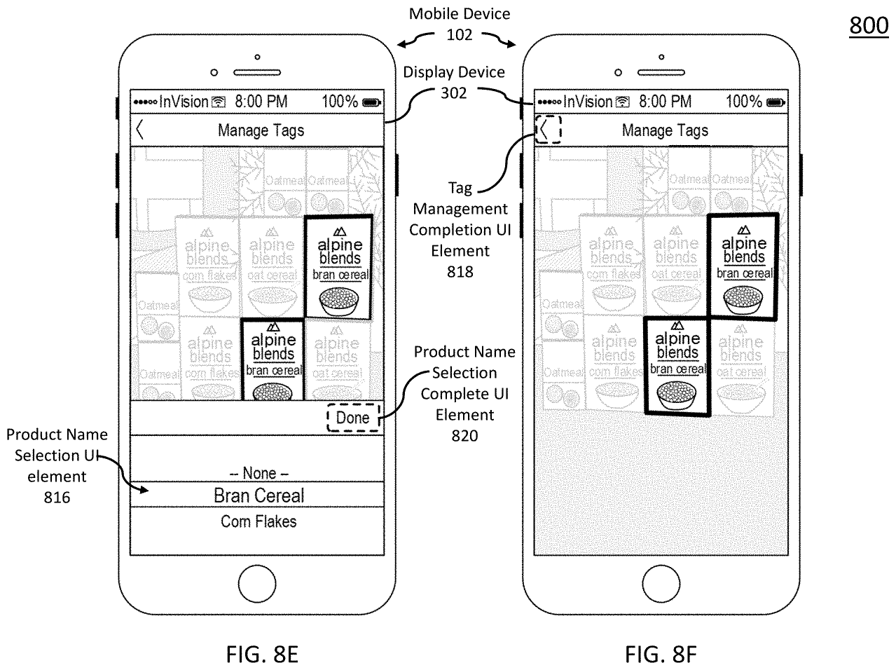

In a third example operation as illustrated in FIG. 1, the user (e.g., a compliance auditor) associated with a product manufacturer may at stage 164-1 request addition or modification of a product tag and update to an associated product name as further discussed and illustrated in FIG. 8A-8F. Moreover, at stage 164-1 the mobile compliance application 112 may transmit a product tag modification request, which may include, without limitation, the one or more user modified product tags and associated user selected product name. In response, at stage 164-2, the mobile compliance backend system 120 may provide the product tag modification request to the compliance API gateway 122. At stage 164-3, the compliance API gateway 122 may provide the product tag modification request to the distributed compliance system 126.

Continuing with the above third example operation at stage 164-4, the distributed compliance system 126 may store the one or more user modified product tags and associated user selected product name as part of a supplemental training dataset and assign an associated dataset identifier. The supplemental training dataset may be stored in the vision support datastores 136 and the associated dataset identifier may be stored in the compliance datastores 134. It is to be appreciated that the distributed compliance system 126, may then request the computer vision API gateway 128 to retrain one or more object recognition models using the supplemental training dataset on a periodic basis in order to improve object recognition based on feedback received from one or more users (e.g., the compliance auditors)

FIG. 2 illustrates a block diagram of an example embodiment 200 of the mobile device 102. It is to be appreciated that while FIG. 2 illustrates one example embodiment of the mobile device 102, the example embodiment is not limited to this context.

In an embodiment, the mobile device 102 may be generally arranged to provide mobile computing and/or mobile communications and may include, but are not limited to, memory 270, communications component 274, motion component 276, and orientation component 278, acoustic input/output component 280, haptic component 282, mobile processor component 284, touch sensitive display component 286, location component 288, internal power component 290, and image acquisition component 294, where each of the components and memory 270 may be operatively connected via interconnect 292.

In an embodiment, the memory 270 may be generally arranged to store information in volatile and/or nonvolatile memory, which may include, but is not limited to, read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM) flash memory, polymer memory such as ferroelectric polymer memory, ovonic memory, phase change or ferroelectric memory, silicon-oxide-nitride-oxide-silicon (SONOS) memory, solid state memory devices (e.g., USB memory, solid state drives SSD, etc.), and/or any other type of storage media configured for storing information.

In an embodiment, the memory 270 may include instruction information arranged for execution by the mobile processor component 284. In that embodiment, the instruction information may be representative of at least one operating system 272, one or more applications, which may include, but are not limited to, mobile compliance application 112. In an embodiment, the memory 270 may further include device datastore 250 which may be configured to store information associated with the mobile compliance application 112 (e.g., audit images, compliance audit information, audit result information, etc.).

In an embodiment, the mobile operating system 272 may include, without limitation, mobile operating systems (e.g., Apple®, iOS®, Google® Android®, Microsoft® Windows Phone®, Microsoft® Windows®, etc.) general arranged to manage hardware resources (e.g., one or more components of the mobile device 102, etc.) and/or software resources (e.g., one or more applications of the mobile device 102, etc.).

In an embodiment, the communications component 274 may be generally arranged to enable the mobile device 102 to communicate, directly and/or indirectly, with various devices and systems (e.g., mobile compliance back end system 120, configuration API gateway 124, Cloud Storage System 114, etc.). The communications component 274 may include, among other elements, a radio frequency circuit (not shown) configured for encoding and/or decoding information and receiving and/or transmitting the encoded information as radio signals in frequencies consistent with the one or more wireless communications standards (e.g., Bluetooth, Wireless IEEE 802.11, WiMAX IEEE 802.16, Global Systems for Mobile Communications (GSM), Enhanced Data Rates for GSM Evolution (EDGE), Long Term Evolution (LTE), Bluetooth standards, Near Field Communications (NFC) standards, etc.).

In an embodiment, the motion component 276 may be generally arranged to detect motion of the mobile device 102 in one or more axes. The motion component 276 may include, among other elements, motion sensor (e.g., accelerometer, micro gyroscope, etc.) to convert physical motions applied to or exerted on the mobile device 118-1 into motion information.

In an embodiment, the orientation component 278 may be generally arranged to detect magnetic fields for measuring the strength of magnetic fields surrounding the mobile device 102. The orientation component 278 may include, among other elements, magnetic sensor (e.g., magnetometer, magnetoresistive permalloy sensor, etc.) to convert magnetic field applied to or exerted on the mobile device 102 into orientation information, which may identify a number of degrees from a reference orientation the mobile device 102 is oriented or otherwise pointed.

In an embodiment, the acoustic input/output (I/O) component 280 may be generally arranged for converting sound, vibrations, or any other mechanical waves received by the mobile device 102 into digital or electronic signals representative of acoustic input information utilizing one or more acoustic sensors (e.g., microphones, etc.), which may be located or positioned on or within the housing, case, or enclosure of the mobile device 102 to form a microphone array. Additionally, the acoustic I/O component 280 may be further arranged to receive acoustic output information and convert the received acoustic output information into electronic signals to output sound, vibrations, or any other mechanical waves utilizing the one or more electroacoustic transducers (e.g., speakers, etc.) which may be located or positioned on or within the housing, case, or enclosure of the mobile device 102. Additionally, or alternatively, the acoustic output information and/or the covered electronic signals may be provided to one or more electroacoustic transducers (e.g., speakers, etc.) operatively coupled to the mobile device 102 via wired and/or wireless connections.

In an embodiment, the haptic component 282 may be generally arranged to provide tactile feedback with varying strength and/or frequency with respect to time through the housing, case, or enclosure of the mobile device 102. Moreover, the haptic component 282 may include, among other elements, a vibration circuit (e.g., an oscillating motor, vibrating motor, etc.) arranged to receive haptic output information and convert the received haptic output information to mechanical vibrations representative of tactile feedback.

In an embodiment, the mobile processor component 284 may be generally arranged to execute instruction information including one or more instructions. In an embodiment, the processor component 284 may be a mobile processor component or system-on-chip (SoC) processor component which may comprise, among other elements, processor circuit, which may include, but is not limited to, at least one set of electronic circuits arranged to execute one or more instructions. Examples of mobile processor components 284 may include, but is not limited to, Qualcomm® Snapdragon®, NVidia® Tegra®, Intel® Atom®, Samsung® Exynos, Apple® A7®-A13®, or any other type of mobile processor(s) arranged to execute the instruction information including the one or more instructions stored in memory 270.

In an embodiment, the touch sensitive display component 286 may be generally arranged to receive and present visual display information, and provide touch input information based on detected touch based or contact based input. Moreover, the touch sensitive display component 286 may include, among other elements, display device (e.g., liquid-crystal display, light-emitting diode display, organic light-emitting diode display, etc.) for presenting the visual display information and touch sensor(s) (e.g., resistive touch sensor, capacitive touch sensor, etc.) associated with the display device to detect and/or receive touch or contact based input information associated with the display device of the mobile device 102. Additionally, the touch sensor(s) may be integrated with the surface of the display device, so that a user's touch or contact input may substantially correspond to the presented visual display information on the display device, such as, for example, one or more user interface (UI) elements discussed and illustrated in FIGS. 3A-3B, 4A-4B, 5A-5D, 6A-6B, 7A-7B, 8A-8F, and 9-10.

In an embodiment, the location component 288 may be generally arranged to receive positioning signals representative of positioning information and provide location information (e.g., approximate physical location of the mobile device 102) determined based at least partially on the received positioning information. Moreover, the location component 288 may include, among other elements, positioning circuit (e.g., a global positioning system (GPS) receiver, etc.) arranged to determine the physical location of the mobile device 102. In some embodiments, the location component 288 may be further arranged to communicate and/or interface with the communications component 274 in order to provide greater accuracy and/or faster determination of the location information.

In an embodiment, the internal power component 290 may be generally arranged to provide power to the various components and the memory of the mobile device 102. In an embodiment, the internal power component 290 may include and/or be operatively coupled to an internal and/or external battery configured to provide power to the various components (e.g., communications component 274, motion component 276, memory 270, etc.). The internal power component 290 may also be operatively coupled to an external charger to charge the battery.

In an embodiment, the image acquisition component 294 may be generally arranged to generate a digital image information using an image capture device such as, for example, a charged coupled device (CCD) image sensor (Not shown). Moreover, the image acquisition component 294 may be arranged to provide or otherwise stream digital image information captured by a CCD image sensor to the touch sensitive display component 286 for visual presentation via the interconnect 292, the mobile operating system 272, mobile processor component 284.

In an embodiment, and as previously discussed, the mobile compliance application 112 may be generally configured to enable a user (e.g., an auditor, sales representative, merchandiser, etc.) associated with a product manufacturer to audit its compliance of one or more planograms at a physical location using cloud based computer vision. Moreover, to enable a user to perform compliance auditing the mobile compliance application 112 may be configured to visually present one or more UI views via the touch sensitive display component 286 as further discussed and illustrated with respect to FIGS. 3A-3B, 4A-4B, 5A-5D, 6A-6B, 7A-7B, 8A-8F, and 9-10. Additionally, the mobile compliance application 112 may be further configured to receive one or more selections of one or more UI elements via the touch sensitive display component 286 as further discussed and illustrated in FIGS. 3A-3B, 4A-4B, 5A-5D, 6A-6B, 7A-7B, 8A-8F, and 9-10. Furthermore, to visually present one or more UI views, the mobile compliance application 112 may be further configured to request and receive various information via the communications component 274 from the mobile compliance backend system 120 as discussed herein.

FIGS. 3A-3B are example UI views 300 for initiating a compliance auditing using cloud based computer vision using the mobile compliance application 112 on a mobile device 102 having a display device 302 based on an example planogram in an example retail store.

As illustrated in FIGS. 3A-3B, a user (e.g., an auditor, sales representative, merchandiser, etc.) associated with a product manufacturer (e.g., consumer goods manufacturer, durable goods manufacturer, etc.) is visiting a geographic location (e.g., “Walmart convenience supercenter” store etc.) to perform an audit of its one or more visual marketing campaigns (e.g., one or more planograms, etc.). For example, and to begin the auditing of its one or more planograms, the auditor may select computer vision assisted compliance audit UI element 304-1 to audit one or more planograms at the “Walmart convenience supercenter.” In response the mobile compliance application 112 may visually present with a set of compliance audits illustrated as compliance audit UI element 304-1, 304-2, 304-3.

As illustrated in FIG. 3B, each compliance audit UI element (e.g., compliance audit UI element, 304-1, 304-2, 304-3, etc.) may visually present on a display of the mobile device 102 at least a portion of compliance audit information transmitted by the distributed compliance system 126 to a mobile device 102 via compliance API gateway 122 and mobile compliance backend system 120. The compliance audit information may include, without limitation, at least an audit identifier that uniquely identifies a particular compliance audit using, for example, an alphanumeric identifier, reference product class that identifies a category of reference products to be audited for a particular compliance audit (e.g., “Cereal Food,” “Energy Drinks,” “Beverages,” etc.), reference product count that identifies a number of reference products that belong to a particular reference product class (e.g., “3 products,” “1 product,” “4 products,” etc.), and audit status that identifies whether a particular compliance audit has been completed (e.g., “yet to audit,” “completed,” etc.).

It can be appreciated that while FIG. 3B (and other figures as discussed herein) may show that each “Fixture ID” for each compliance Audit UI elements 304 are the same, however, in some implementations, at least some of the “Fixture ID” may be different. For example, in some implementations, the “Fixture ID” for each compliance audit UI element 304 may be a unique alphanumeric identifier (e.g., “Fixture ID 124423,” “Fixture ID 3490257,” etc.). Additionally, in some implementations, the audit identifier for a particular compliance audit having corresponding compliance audit information may include or otherwise be generated based on the “Fixture ID” as shown in a corresponding compliance audit UI element 304 (e.g., compliance audit UI element 304-1 having “Fixture ID 124423,” etc.).

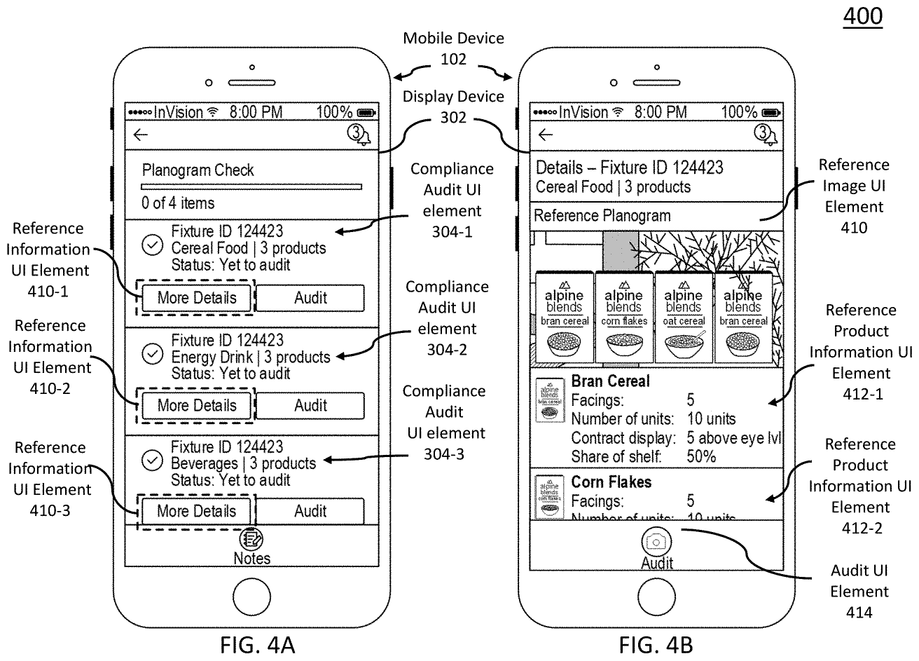

FIGS. 4A-4B illustrate example UI views 400 of the mobile compliance application 112 on a mobile device 102 having a display device 302 for viewing reference product information associated with an example compliance audit.

As illustrated in FIG. 4A, each compliance audit UI element 304-1, 304-2, 304-3 may further include, without limitation, at least a reference information UI element 410-1, 410-2, 410-2, respectively. A user may select, via the touch sensitive display component 286 of its mobile device 102, a reference information UI element (e.g., reference information UI element 410-1 for “Cereal Food|3 products,” etc.) to view additional compliance audit information for a particular compliance audit. Moreover, after the user selects the reference information UI element 410-1, the mobile compliance application 112 may visually present additional compliance audit information as shown in FIG. 4B on the display of the mobile device 102.

As illustrated in FIG. 4B, the compliance audit information visually presented on the display of the mobile device may include the previous information shown (e.g., reference product class, reference product count, etc.) further include a reference image UI element 410 and one or more reference product information UI elements 410-1, 410-2. The reference image UI element 410 may visually present a reference image that is considered compliant with respect to a product manufacturer's requirements. The one or more reference product information UI elements 410-1, 410-2 may each correspond to a reference product in a set of reference products included in the reference image. As such, the one or more reference product information UI elements 410-1, 410-2 may visually present reference product information for each reference product associated with a compliance audit (e.g., compliance audit associated with compliance audit UI element 304-1, etc.). Additionally, the user may also select the audit UI element 414 to begin an audit for the selected compliance audit as further illustrated and discussed in FIG. 5B.

In one embodiment, the reference product information for each reference product may include, without limitation, a reference product image that represents a digital image of a physical product for sale within the reference image (e.g., yellow box labeled “Bran Cereal,” green box labeled “Corn Flakes,” etc.), a reference product name identifying a name (or label) of the reference product (e.g., “Bran Cereal,” “Corn Flakes,” etc.), a reference product placement description that identifies a placement location of the reference product and a number of facings at the placement location (e.g., “5 above eye level,” “2 below eye level,” “10 at eye level,” etc.), a reference product facing count that indicates a number of facings for the reference product within the reference image, and a reference product share of shelf that identifies a percentage of the reference product facing count as compared to all available facings within the reference image (e.g., “50%,” “10%,” etc.) The reference product information for each reference product may further include, without limitation, reference product unit count to identify a number of units for that reference product that are expected (e.g., 10 units, 20 units 15 units, etc.)

FIGS. 5A-5D illustrate example UI views 500 of the mobile compliance application 112 on a mobile device 102 having a display device 302 for performing an example compliance audit in the example retail store.

As illustrated in FIG. 5A, each compliance audit UI element 304-1, 304-2, 304-3 may further include, without limitation, at least an audit UI element 510-1, 510-2, 510-3, respectively. A user may select, via the touch sensitive display component 286 of its mobile device 102, an audit UI element (e.g., audit UI element 510-1 for “Cereal Food|3 products,” etc.) to view additional compliance audit information for a particular compliance audit. Moreover, after the user selects an audit UI element (e.g., audit UI element 510-1 for “Cereal Food|3 products,” etc.), the mobile compliance application 112 may visually present, on the touch sensitive display component 286, a live preview UI element 512.

As illustrated in FIG. 5B, the live preview UI element 512 may visually present streamed digital image information captured by a CCD image sensor of the image acquisition component 294 at a specific frame rate (e.g., 30 frames per second, 60 frames per second, etc.) for visual presentation on the display of the mobile device 102 at substantially the same or different frame rate. The user may then physically move his or her mobile device 102 and consequently, also physically move the image acquisition component 294 of the mobile device 102 to capture an image of, for example, a planogram associated with the particular compliance audit. To capture an audit image for the selected compliance audit, the user may select the capture audit image UI element 512, which may be stored in the device datastore 250.

As illustrated in FIG. 5C, after the user selects capture audit image UI element 512 to capture an audit image, the audit image is then displayed in the audit image UI element 514. The user may then select the use audit image UI element 516 to transmit the captured audit image stored in the device datastore 250 to the mobile compliance backend system 120. In response, the computer vision system 130 of the cloud computer vision compliance system 100 may recognize one or more products within the audit image. Additionally, the mobile compliance application 112 may also receive audit result information for a particular compliance audit (e.g., compliance audit associated with compliance audit UI element 304-1 for “Cereal Food|3 products,” etc.) from the mobile compliance backend system 120.

As illustrated in FIG. 5D, after receiving the audit result information for a particular compliance audit (e.g., compliance audit associated with compliance audit UI element 304-1 for “Cereal Food|3 products,” etc.), at least a portion of the audit result information and reference product information for each reference product in a particular audit may be visually presented in one or more recognized product tag UI elements 520-1, 522-1, 518-1, and 518-2 and visually presented in the product performance overview UI element 530.

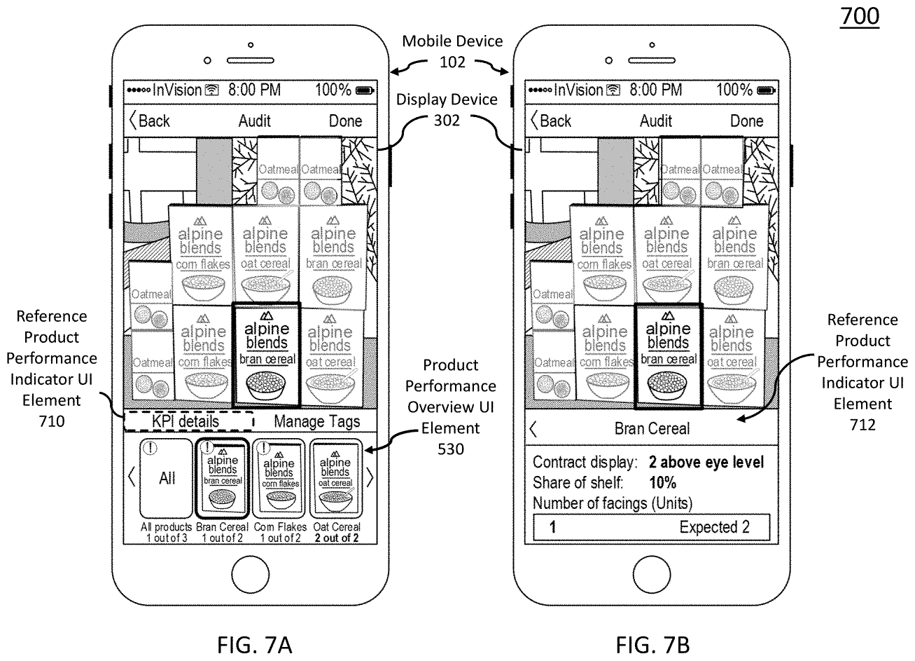

In one embodiment, the audit result information may include, without limitation, a set of recognized products (e.g., “Bran Cereal,” “Corn Flakes,” “Oat Cereal,” etc.), where each product may be represented as recognized product information and product performance indicator information (further discussed with respect to FIG. 7A-7B). For example, and as illustrated in FIG. 5D, the recognized product information for each recognized product may include, without limitation, at least one recognized product tag that identifies a rectangular region of a recognized product within the audit image. Additionally, each rectangular region may be visually presented as an annotation in the audit image as illustrated in FIG. 5D. As such, the recognized product tag UI element 520-1 (e.g., recognized product with recognized product name of “Corn Flakes”), the recognized product tag UI element 522-1 (e.g., recognized product with recognized product name of “Bran Cereal”), and the recognized product tag UI elements 518-1, 518-2 ((e.g., recognized product with recognized product name of “Oat Cereal”) may all be visually presented as recognized product tags.

In one embodiment, each the recognized product tag may include, without limitation, at least a minimum X coordinate and a minimum Y coordinate (e.g., upper left corner) and a maximum X coordinate and maximum Y coordinate (e.g., lower right corner) defining at least two diagonal corners (e.g., upper left and lower right corners, etc.) of a rectangular overlay region of where the recognized product is located within the audit image. It is to be appreciated that while the rectangular overlay regions are illustrated or outlined in a specific color (e.g., white, etc.), other colors may be used, and the colors may vary for each recognized product so that they may be easily identified and distinguished among other recognized products.

Additionally, while not illustrated in FIG. 5D but further illustrated in FIG. 7B, the recognized product information for each recognized product may further include a recognized product name identifying a name (or label) of the recognized product, a recognized product unique identifier that may uniquely identify the recognized product, a recognized product placement description that may identify a placement location of the recognized product and a number of facings at that placement location, a recognized product facing count that may indicate a number of facings for a recognized within the audit image, a recognized product share of shelf that may identify a percentage of the recognized product facing count as compared to all available facings within the reference image of the compliance audit information.

Also, illustrated in the FIG. 5D, the product performance overview UI element 530 may visually present at least a portion of the reference product information for each reference product in a set of reference products that are expected to be within a visual marketing campaign (e.g., planogram) associated with a particular compliance audit. For example, as illustrated in FIG. 5D, the product performance overview UI element 530 may visually present reference product images (e.g., yellow box labeled “Bran Cereal,” green box labeled “Corn Flakes,” blue box labeled “Oat Cereal,” etc.) and corresponding reference product name that are expected to be within a particular planogram associated with a particular compliance audit.

Additionally, the product performance overview UI element 530 may further visually present at least a portion of product performance indicator information for a compliance audit. For example, with respect to reference product “Bran Cereal,” the product performance overview UI element 530 may visually present at least a portion of the product performance information (e.g., facing count comparison information) as “1 out of 2” in colored text (e.g., red text) to indicate that one facing of the “Bran Cereal” reference product was recognized by the computer vision system 130 out of two facings of the “Bran Cereal” reference product was expected and so forth. Similarly, with respect to reference product “Oat Cereal,” the product performance overview UI element 530 may visually present at least a portion of the product performance information (e.g., facing count comparison information) as “2 out of 2” in colored text (e.g., green text) to indicate that two facing of the “Oat Cereal” reference product was recognized by the computer vision system 130 out of two facings of the “Oat Cereal” reference product was expected and so forth.

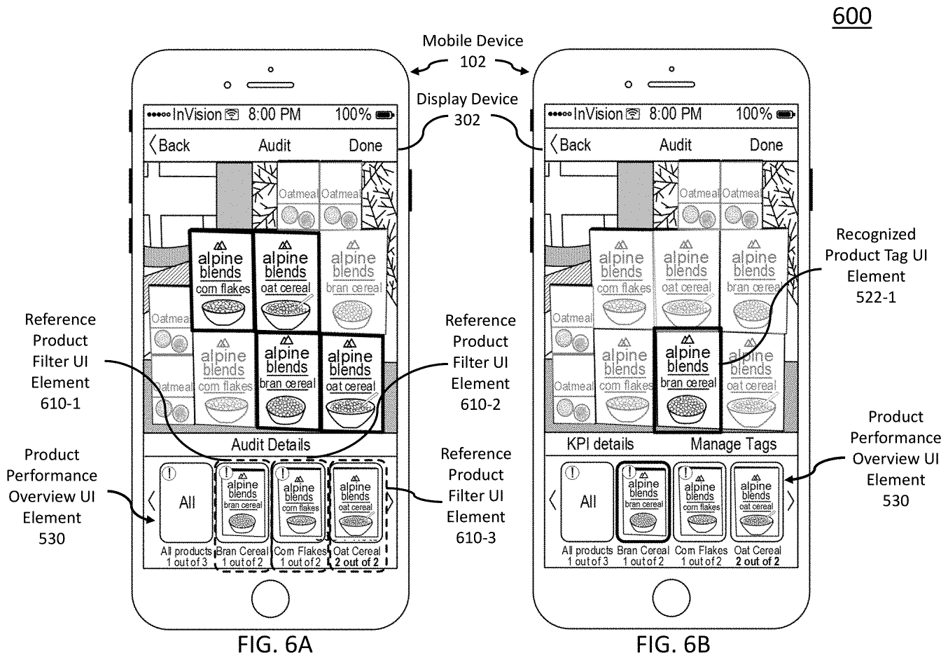

FIGS. 6A-6B illustrate example UI views 600 of the mobile compliance application 112 on a mobile device 102 having a display device 302 for filtering visually presented recognized product information associated with an example compliance audit.

As illustrated in FIG. 6A and previously discussed with respect to FIG. 5D, the product performance overview UI element 530 may visually present at least a portion of the reference product information for each reference product in a set of reference products that are expected to be within a visual marketing campaign (e.g., planogram) associated with a particular compliance audit. Additionally, as illustrated in FIG. 6A, each of the reference products may be visually represented as reference product filter UI element 610-1, 610-2, 610-3. A user may select a reference product filter UI element (e.g., reference product filter UI element 610-1, etc.) to filter out any other recognized product tag UI elements being overlaid on top the audit image that do not correspond the reference product selected by the user. Additionally, varying text color (e.g., red rather than green text, etc.) and/or indicators (e.g., red exclamation point, etc.) may be used to highlight any reference product having corresponding reference product filter UI element that do not meet expectations (i.e., out-of-compliance) as set forth by the product manufacturer after compliance audit (e.g., reference product filter UI element 610-1, 610-2).

For example, and as illustrated in FIG. 6B, after a user selects one of reference product filter UI elements (e.g., reference product filter UI elements 610-1) associated with a particular reference product (e.g., reference product with reference product name “Bran Cereal”), all other recognized product tag UI elements illustrated as annotations in the audit image in FIG. 5D that do not correspond to the particular selected reference product are removed (recognized product tag UI elements 520-1, 518-1, 518-2) so that only the recognized product tag UI element(s) corresponding to the reference product is overlaid on the audit image (e.g., recognized product tag UI elements 522-1).

FIGS. 7A-7B illustrate example UI views 700 of the mobile compliance application 112 on a mobile device 102 having a display device 302 for viewing at least a portion of reference product information and/or product performance indicator information associated with an example compliance audit.

As illustrated in FIG. 7A and after a user selects one of reference product filter UI elements (e.g., reference product filter UI element 610-1) as illustrated in FIG. 6B, the user may further select the reference product performance indicator UI element 710 to view recognized product information for a recognized product that corresponds to a selected reference product after a compliance audit.

As illustrated in FIG. 7B, and after the user selects the reference product performance indicator UI element 712, the reference product performance indicator UI element 712 may visually present at least a portion of reference product information for a selected reference product (e.g., reference product with reference product name “Bran Cereal”). Additionally, thee reference product performance indicator UI element 712 may also visually present at least a portion of recognized product information for a recognized product (e.g., recognized product with recognized product name “Bran Cereal”) that corresponds to the selected reference product.

For example, reference product information as visually presented may include, without limitation, the reference product name (e.g., “Bran Cereal”), and facing count comparison information (e.g., “Number of facings (Units) 1 Expected 2”). Additionally, the recognized product information as visually presented in the reference product performance indicator UI element 712 may include, without limitation, recognized product placement description (e.g., “2 above eye level”), and a recognized product share of shelf (e.g., “10%”).

FIGS. 8A-8F illustrate example UI views 800 of the mobile compliance application 112 on a mobile device 102 having a display device 302 for providing user feedback to the cloud based computer vision compliance system 170 by adding or modifying a product tag for a product that was not recognized in an example compliance audit.

As illustrated in FIG. 8A, and after the user selects the reference product performance indicator UI element 710, the user may also select the tag management UI element 810 to manage product tags for a specific reference product. In one embodiment, the user may add a new product tag or modify an existing product tag and updating its associated product name that were not initially properly recognized by the cloud based computer vision compliance system 100. It is to be appreciated that by adding new product tag or modifying an existing product tag and updating its associated product name, the cloud based computer vision compliance system 100 may be further trained to better recognize existing reference products or even recognize new products.

As illustrated FIG. 8B, after the user selects the tag management UI element 810, instructions to add or modify a product tag is shown. As illustrated in FIG. 8C, a bounding box UI element 812 is visually presented on the display of the mobile device as a modifiable rectangular region overlaying or otherwise annotating the previously stored audit image. The user may then modify the bounding box UI element 812, via the touch sensitive display component 286, to resize the modifiable rectangular region to outline and highlight an unrecognized product within the audit image.

As illustrated in FIG. 8D, once the user is satisfied with size and position of bounding box UI element 812, the user may select either “OK” in the bounding box UI element 814 to save it or “remove” to start over. As illustrated in FIG. 8E, after user selects “OK” in the bounding box UI element 814, the user may then be presented a product name selection UI element 816 to select a product name (or remove a product name that was improperly recognized) associated with the saved rectangular region that outlines and/or highlights a previously unrecognized product. In one embodiment, the product name may be limited to a set of reference products associated with the particular compliance audit. To complete the selection of a product name associated with the saved rectangular region, the user may select the product name selection complete UI element 820.

As illustrated in FIG. 8F, and after the user completes the selection of a product name, the user may then select the tag management completion UI element 818 to complete the management of product tags. Additionally, it is to be appreciated that sometime during or after the completion of management of product tags, mobile compliance application 112 may be further configured to determine one or more user modified product tags where each user modified product tag includes at least a minimum X coordinate and a minimum Y coordinate and a maximum X coordinate and maximum Y coordinate defining at least two diagonal corners (e.g., upper left corner and lower right corner, etc.) of the modified rectangular region.

Additionally and sometime during or after the completion of management of product tags, the mobile compliance application 112 may be further configured to correlate or associate a user selected product name for each user modified product tag. After determining the one or more modified product tags and one or more user selected product names has been associated (e.g., after selecting product name selection complete UI element 820, after selecting the tag management completion UI element 818, etc.) the mobile compliance application 112 may also be configured to transmit the one or more user modified product tags and associated user select product name to the mobile compliance backend system 120 where they may be stored in one or more datastores (e.g., vision support datastores 136) as one or more datasets (e.g., supplemental training datasets, etc.) used by the computer vision system 130 to further train one or more object recognition models.

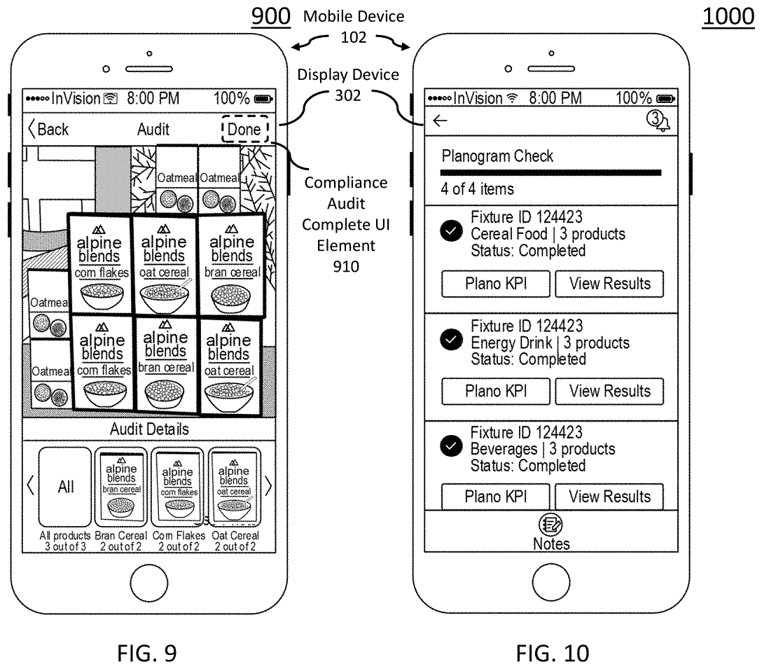

FIG. 9 illustrates an example UI view 900 of the mobile compliance application 112 on mobile device 102 having a display device 302 after recognizing all products and/or adding product tags for all unrecognized products in an example compliance audit. Moreover, the mobile compliance application 112 may visually present the UI view 900 as shown in FIG. 9 after the user completes the operations as discussed with respect to at least FIGS. 5A-5D and 8A-8F for a particular compliance audit. Additionally, the user may select the Compliance Audit Complete UI Element 910 to finish the particular compliance audit and continue onto another compliance audit as illustrated in FIG. 3B (e.g., compliance audit visually presented by Compliance Audit UI element 304-2 and/or 304-3.).

FIG. 10 illustrates an example UI view 1000 of the mobile compliance application 112 on mobile device 102 having a display device 302 after all example compliance audits have been completed. Moreover, the mobile compliance application 112 may visually present the UI view 1000 as shown in FIG. 10 after the user completes all compliance audits at a specific geographic location (e.g., “Walmart convenience supercenter” store, etc.) as discussed with respect to at least FIGS. 3A-3B, 5A-5D, and 8A-8F.

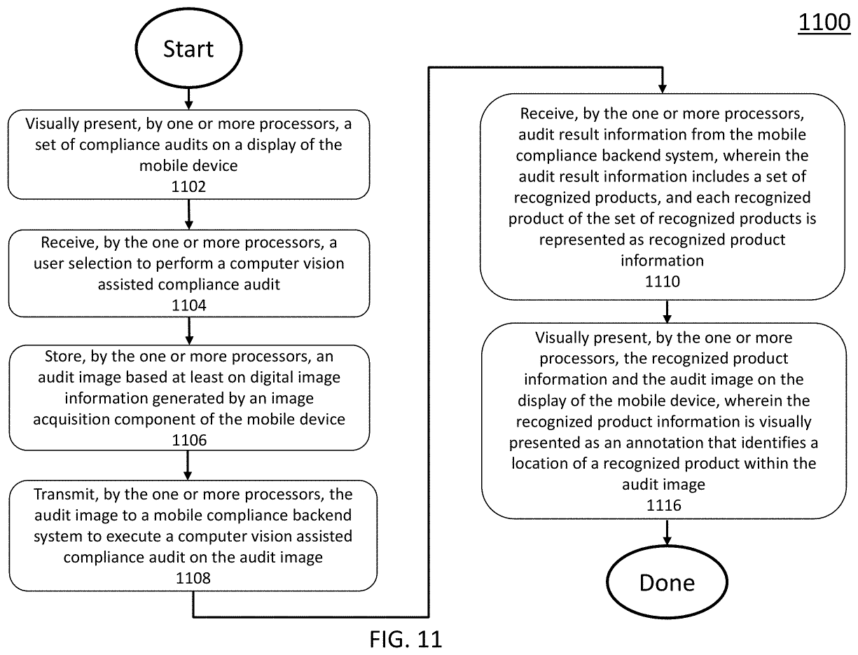

FIG. 11 illustrates an example logic flow 1100 for performing an example compliance audit on a mobile device 102. It is to be appreciated that depending on implementation, not all stages need to be performed. Nor do all stages need to be performed in the order as illustrated. Additionally, one or more stages may be combined with other disclosures as discussed herein (e.g., discussions of FIGS. 1-10, and 11).

As illustrated in FIG. 11 the logic flow may begin at stage 1102, where a mobile device 102 (e.g., mobile compliance application 112, etc.) may visually present, by one or more processors, a set of compliance audits on a display of the mobile device. At stage 1104, the mobile device 102 may receive, by the one or more processors, a user selection to perform a computer vision assisted compliance audit. At stage 1106, the mobile device 102 may store, by the one or more processors, an audit image based at least on digital image information generated by an image acquisition component of the mobile device. At stage 1106, the mobile device 102 may transmit, by the one or more processors, the audit image to a mobile compliance backend system 120 to execute a computer vision assisted compliance audit on the audit image.

At stage 1110, the mobile device 102 may receive, by the one or more processors, audit result information from the mobile compliance backend system, wherein the audit result information includes a set of recognized products, and each recognized product of the set of recognized products is represented as recognized product information. At stage 1112, the mobile device 102 may visually present, by the one or more processors, the recognized product information and the audit image on the display of the mobile device, wherein the recognized product information is visually presented as an annotation that identifies a location of a recognized product within the audit image and the logic flow may then end.

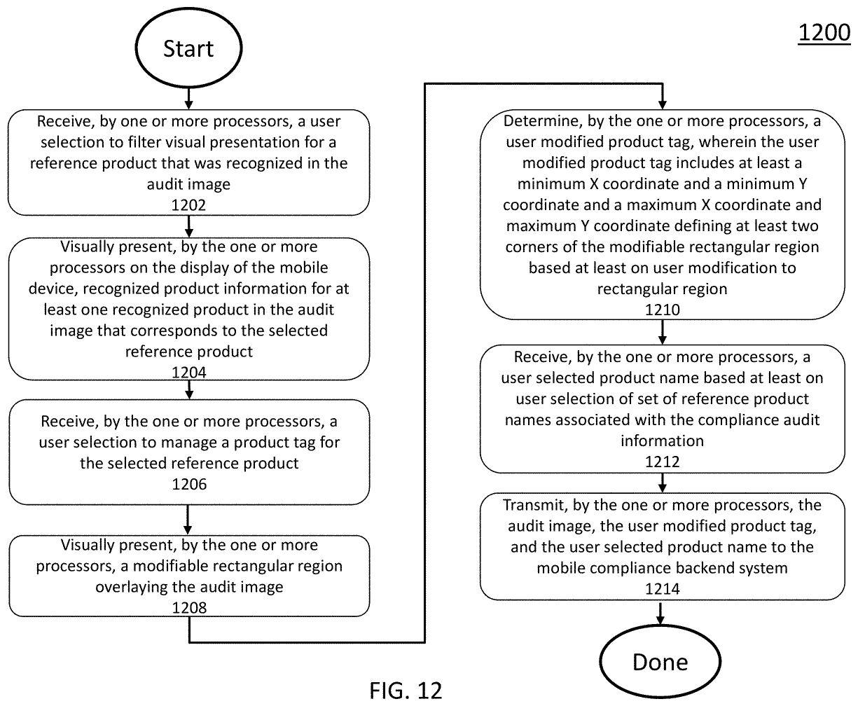

FIG. 12 illustrates an example logic flow 1200 for modifying product tags associated with a compliance audit on a mobile device 102. It is to be appreciated that depending on implementation, not all stages need to be performed. Nor do all stages need to be performed in the order as illustrated. Additionally, one or more stages may be combined with other disclosures discussed herein (e.g., discussions of FIGS. 1-11).

As illustrated in FIG. 12 the logic flow may begin at stage 1202, where a mobile device 102 (e.g., mobile compliance application 112, etc.) may receive, by one or more processors, a user selection to filter visual presentation for a reference product that was recognized in the audit image. At stage 1204, the mobile device 102 may visually present, by the one or more processors on the display of the mobile device, recognized product information for at least one recognized product in the audit image that corresponds to the selected reference product. At stage 1206, the mobile device 102 may receive, by the one or more processors, a user selection to manage a product tag for the selected reference product. At stage 1208, the mobile device 102 may visually present, by the one or more processors, a modifiable rectangular region overlaying the audit image.

At stage 1210, the mobile device 102 may determine, by the one or more processors, a user modified product tag, wherein the user modified product tag includes at least a minimum X coordinate and a minimum Y coordinate and a maximum X coordinate and maximum Y coordinate defining at least two corners of the modifiable rectangular region based at least on user modification to rectangular region. At stage 1212, the mobile device 102 may receive, by the one or more processors, a user selected product name based at least on user selection of set of reference product names associated with the compliance audit information. At stage 1214, may transmit, by the one or more processors, the audit image, the user modified product tag, and the user selected product name to the mobile compliance backend system 120.

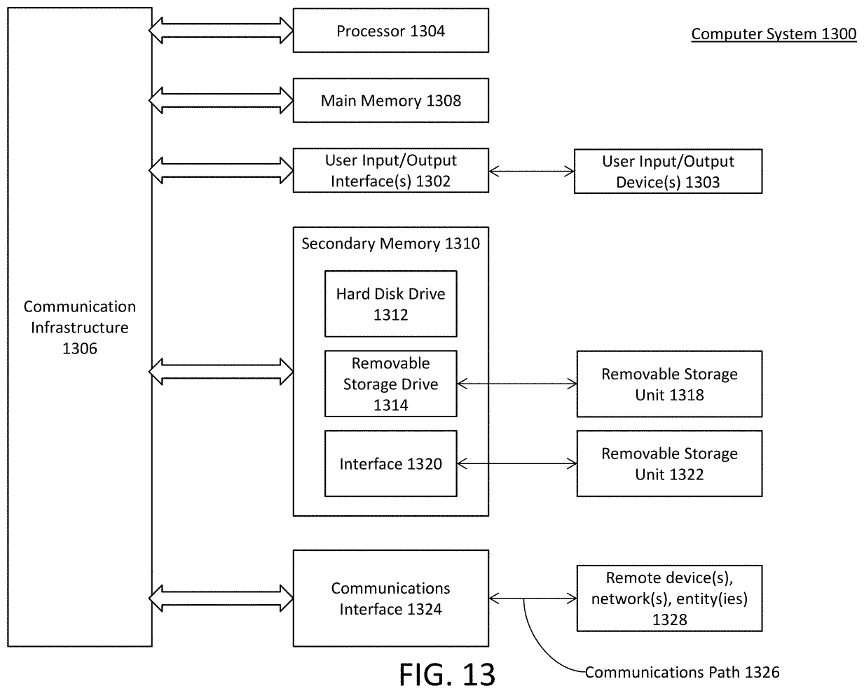

FIG. 13 illustrates an example computer system useful for implementing various embodiments. Moreover, various embodiments may be implemented, for example, using one or more well-known computer systems, such as computer system 1300 shown in FIG. 13. One or more computer systems 1300 may be used, for example, to implement any of the embodiments discussed herein, as well as combinations and sub-combinations thereof. For example, the computer system 1300 may implement the computing device 104. In another example, one or more computing systems 1300 may be communicatively coupled to each other, where each is configured to execute one or more virtual machines (not shown). The one or more virtual machines may be managed or otherwise orchestrated by one or more virtual machine managers (not shown) configured to provision and/or configure one or more virtual machines to the one or more computing systems 1300. The one or more virtual machines may be further configured as a Software as a Service (SaaS), Platform as a Service (PaaS) and/or an Infrastructure as a Service (IaaS) provider configured to host or otherwise execute one or more applications associated with one or more gateways, systems, and/or datastores of FIG. 1.

Computer system 1300 may include one or more processors (also called central processing units, or CPUs), such as a processor 1304. Processor 1304 may be connected to a communication infrastructure or bus 1306.

Computer system 1300 may also include customer input/output device(s) 1303, such as monitors, keyboards, pointing devices, etc., which may communicate with communication infrastructure 1306 through customer input/output interface(s) 1302.

One or more of processors 1304 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1300 may also include a main or primary memory 1308, such as random access memory (RAM). Main memory 1308 may include one or more levels of cache. Main memory 1308 may have stored therein control logic (i.e., computer software) and/or data.

Computer system 1300 may also include one or more secondary storage devices or memory 1310. Secondary memory 1310 may include, for example, a hard disk drive 1312 and/or a removable storage device or drive 1314. Removable storage drive 1114 may be a floppy disk drive, a magnetic tape drive, a compact disk drive, an optical storage device, tape backup device, and/or any other storage device/drive.

Removable storage drive 1314 may interact with a removable storage unit 1318. Removable storage unit 1318 may include a computer usable or readable storage device having stored thereon computer software (control logic) and/or data. Removable storage unit 1318 may be a floppy disk, magnetic tape, compact disk, DVD, optical storage disk, and/ any other computer data storage device. Removable storage drive 1314 may read from and/or write to removable storage unit 1318.

Secondary memory 1310 may include other means, devices, components, instrumentalities or other approaches for allowing computer programs and/or other instructions and/or data to be accessed by computer system 1300. Such means, devices, components, instrumentalities or other approaches may include, for example, a removable storage unit 1322 and an interface 1320. Examples of the removable storage unit 1322 and the interface 1320 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1300 may further include a communication or network interface 1324. Communication interface 1324 may enable computer system 1300 to communicate and interact with any combination of external devices, external networks, external entities, etc. (individually and collectively referenced by reference number 1328). For example, communication interface 1324 may allow computer system 1300 to communicate with external or remote devices 1328 over communications path 1326, which may be wired and/or wireless (or a combination thereof), and which may include any combination of LANs, WANs, the Internet, etc. Control logic and/or data may be transmitted to and from computer system 1300 via communication path 1326.

Computer system 1300 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof

Computer system 1300 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1300, main memory 1308, secondary memory 1310, and removable storage units 1318 and 1322, as well as tangible articles of manufacture embodying any combination of the foregoing. Such control logic, when executed by one or more data processing devices (such as computer system 1300), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 13. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A mobile device, comprising:
a memory configured to store operations; and
one or more processors configured to perform the operations, the operations comprising:
displaying a set of compliance audits on a display of the mobile device, wherein a compliance audit of the set of compliance audits is represented as compliance audit information and includes at least an audit identifier and associated audit status information;
receiving a user selection to perform a computer vision assisted compliance audit;
storing an audit image based at least on digital image information generated by an image acquisition component of the mobile device;
transmitting the audit image to a mobile compliance backend system to execute a computer vision assisted compliance audit on the audit image;
receiving, audit result information from the mobile compliance backend system, wherein the audit result information includes a set of recognized products, and a recognized product of the set of recognized products is represented as recognized product information; and
displaying the recognized product information and the audit image on the display of the mobile device, wherein the recognized product information is displayed as an annotation that identifies a location of a recognized product within the audit image.

2. The mobile device of claim 1, wherein
the compliance audit information includes a reference image that is compliant and includes of one or more reference products for sale as arranged at a physical location,
the compliance audit information further includes a set of reference products included in the reference image, wherein a reference product is represented as reference product information, and
the reference product information for each reference product includes a reference product image that represents a digital image of a physical product for sale within the reference image, a reference product name identifying a name of a reference product, a reference product placement description that identifies a placement location of the reference product and a number of facings at the placement location, a reference product facing count that indicates a number of facings for the reference product within the reference image, and a reference product share of shelf that identifies a percentage of the reference product facing count as compared to all available facings within the reference image.

3. The mobile device of claim 2, wherein
the reference product information for a reference product includes at least one reference product tag that identifies a rectangular region of a reference product within the reference image, and
the reference product tag includes at least a minimum X coordinate and a minimum Y coordinate and a maximum X coordinate and maximum Y coordinate defining at least two corners of a rectangular region of where the reference product is located within the reference image.

4. The mobile device of claim 2, wherein
the recognized product information for the recognized product includes at least one recognized product tag that identifies a rectangular region of a recognized product within the audit image;
the recognized product tag includes at least a minimum X coordinate and a minimum Y coordinate and a maximum X coordinate and maximum Y coordinate defining at least two corners of a rectangular region of wherein the recognized product is located within the audit image; and
the recognized product information for the recognized product further includes a recognized product name identifying a name of the recognized product, a recognized product unique identifier that uniquely identifies the recognized product, a recognized product placement description that identifies a placement location of the recognized product and a number of facings at the placement location, a recognized product facing count that indicates a number of facings for a recognized within the audit image, a recognized product share of shelf that identifies a percentage of the recognized product facing count as compared to all available facings within the reference image of the compliance audit information.

5. The mobile device of claim 4, wherein
the audit result information includes product performance indicator information determined based at least on a comparison between the compliance audit information and the recognized product information.

6. The mobile device of claim 4, wherein
the audit result information includes out-of-compliance product information for at least one product that was not recognized in the audit image,
the out-of-compliance product information for the at least one product that was not recognized includes an unrecognized product tag identifying a rectangular region where a specific product was expected to be within the audit image but was not recognized.

7. The mobile device of claim 3, wherein the audit image information represents a digital image of one or more physical products for sale as arranged at a physical location from a view point captured by an image capture component of the mobile device.

8. The mobile device of claim 4, wherein the mobile compliance backend system is configured to request a distributed compliance system to
validate, by the distributed compliance system, the audit image for compliance with an image format and image size associated with a computer vision system configured to recognize one or more products within the audit image;
transmit by the distributed compliance system, the audit image to the computer vision system to recognize at least one product within the audit image by applying one or more previously trained object recognition models; and
receive, by the distributed compliance system from the computer vision system, at least a portion of the recognized product information for at least one recognized product within the audit image.

9. The mobile device of claim 4, wherein the operations further comprising:
receiving a user selection to filter visual presentation for a reference product that was recognized in the audit image, and displaying the recognized product information for at least one recognized product in the audit image that corresponds to the selected reference product.

10. The mobile device of claim 9, wherein the operations further comprising:
receiving a user selection to manage a product tag for the selected reference product,
displaying a modifiable rectangular region overlaying the audit image,
determining a user modified product tag, wherein the user modified product tag includes at least a minimum X coordinate and a minimum Y coordinate and a maximum X coordinate and maximum Y coordinate defining at least two corners of the modifiable rectangular region based at least on user modification to rectangular region, and
receiving a user selected product name based at least on user selection of set of reference product names associated with the compliance audit information.

11. The mobile device of claim 10, wherein the operations further comprising:
transmitting, the audit image, the user modified product tag, and the user selected product name to the mobile compliance backend system, wherein the mobile compliance backend system is configured to request the distributed compliance system to:
store, by the distributed compliance system, the audit image, the user modified product tag, and the user selected product name in persistent compliance datastore, and
request, the distributed compliance system by the distributed compliance system, to update at least one object recognition model based on the audit image, the user modified product tag, and the user selected product name stored in persistent compliance datastore.

12. A computer implemented method, comprising:
displaying, by one or more processors, a set of compliance audits on a display of a mobile device, wherein a compliance audit is represented as compliance audit information and includes at least an audit identifier and associated audit status information;
receiving, by the one or more processors, a user selection to perform a computer vision assisted compliance audit;
storing, by the one or more processors, an audit image based at least on digital image information generated by an image acquisition component of the mobile device;
transmitting, by the one or more processors, the audit image to a mobile compliance backend system to execute a computer vision assisted compliance audit on the audit image;
receiving, by the one or more processors, audit result information from the mobile compliance backend system, wherein the audit result information includes a set of recognized products, and the recognized product of the set of recognized products is represented as recognized product information; and
displaying, by the one or more processors, the recognized product information and the audit image information on the display of the mobile device, wherein the recognized product information is displayed as an annotation that identifies a location of a recognized product within the audit image.

13. The computer implemented method of claim 12, wherein
the compliance audit information includes a reference image that is compliant and includes of one or more reference products for sale as arranged at a physical location, and
the compliance audit information further includes a set of reference products included in the reference image, wherein a reference product of the set of reference products is represented as reference product information.

14. The computer implemented method of claim 13, wherein
the reference product information for the reference product includes a reference product image that represents a digital image of a physical product for sale within the reference image, a reference product name identifying a name of a reference product, a reference product placement description that identifies a placement location of the reference product and a number of facings at the placement location, a reference product facing count that indicates a number of facings for the reference product within the reference image, and a reference product share of shelf that identifies a percentage of the reference product facing count as compared to all available facings within the reference image

15. The computer implemented method of claim 13, wherein
the reference product information for a reference product includes at least one reference product tag that identifies a rectangular region of a reference product within the reference image, and
the reference product tag includes at least a minimum X coordinate and a minimum Y coordinate and a maximum X coordinate and maximum Y coordinate defining at least two corners of a rectangular region of where the reference product is located within the reference image.

16. The computer implemented method of claim 12, wherein the audit image information represents a digital image of one or more physical products for sale as arranged at a physical location from a view point captured by an image capture component of the mobile device.

17. A computer readable storage device having instructions stored thereon, execution of which, by one or more processing devices, causes the one or more processing devices to perform operations comprising:
displaying, by the one or more processing devices, a set of compliance audits on a display of a mobile device, wherein a compliance audit of the set of compliance audits is represented as compliance audit information and includes at least an audit identifier and associated audit status information;
receiving, by the one or more processing devices, a user selection to perform a computer vision assisted compliance audit;
storing, by the one or more processing devices, an audit image based at least on digital image information generated by an image acquisition component of the mobile device;
transmitting, by the one or more processing devices, the audit image to a mobile compliance backend system to execute a computer vision assisted compliance audit on the audit image;
receiving, by the one or more processing devices, audit result information from the mobile compliance backend system, wherein the audit result information includes a set of recognized products, and a recognized product of the set of recognized products is represented as recognized product information; and
displaying, by the one or more processing devices, the recognized product information and the audit image information on the display of the mobile device, wherein the recognized product information is displayed as an annotation that identifies a location of a recognized product within the audit image.

18. The computer readable storage device of claim 17, wherein
the compliance audit information includes a reference image that is compliant and includes of one or more reference products for sale as arranged at a physical location, and
the compliance audit information further includes a set of reference products included in the reference image, wherein a reference product of the set of reference products is represented as reference product information.

19. The computer readable storage device of claim 18, wherein
the reference product information for a reference product includes at least one reference product tag that identifies a rectangular region of a reference product within the reference image, and
the reference product tag includes at least a minimum X coordinate and a minimum Y coordinate and a maximum X coordinate and maximum Y coordinate defining at least two corners of a rectangular region of where the reference product is located within the reference image.

20. The computer readable storage device of claim 18, wherein
the audit image information represents a digital image of one or more physical products for sale as arranged at a physical location from a view point captured by an image capture component of the mobile device.
